(19) United States
(12) Patent Application Publication
(10) Pub. No.: US 2023/0249386 A1
(43) Pub. Date: Aug. 10, 2023

(54) INJECTION MOLDING MACHINE CONTROL DEVICE AND PROGRAM

(71) Applicant: FANUC CORPORATION, Yamanashi (JP)

(72) Inventor: Kensuke NAMIKI, Yamanashi (JP)

(73) Assignee: FANUC CORPORATION, Yamanashi (JP)

(21) Appl. No.: 17/997,588

(22) PCT Filed: May 14, 2021
(86) PCT No.: PCT/JP2021/018469

§ 371 Date: Apr. 13, 2023

(30) Foreign Application Priority Data
May 18, 2020 (JP) 2020-086997

(51) Int. Cl. B29C 45/78; B29C 45/74

(52) U.S. Cl. CPC B29C 45/78; B29C 45/74

(57) ABSTRACT

Provided are an injection molding machine control device and a program that can improve the accuracy of a calculated heat dissipation quantity of a heater. The present invention is provided with: an operation information acquisition unit 12 that acquires the heater output of a heater 102 and the set temperature of the heater 102 for a prescribed period immediately preceding a prescribed time as operation information; a surface temperature acquisition unit 15 that acquires the surface temperature of the heater 102 for the prescribed period included in the acquired operation information; a characteristic information acquisition unit 21 that acquires characteristic information on a characteristic relating to heat dissipation of the heater 102; a results information acquisition unit 14 that acquires, as results information, results of transitions in the ratios of the surface temperature and the set temperature of the heater 102 to transitions in heater output of the heater 102; an estimation unit 17 that estimates the surface temperature of the heater 102 at the prescribed time on the basis of the operation information, the results information, and the acquired surface temperature; and a heat dissipation quantity calculation unit 22 that calculates a heat dissipation quantity from a surface of the heater 102 to the atmosphere on the basis of the estimated surface temperature and the characteristic information.

### TECHNICAL FIELD

The present disclosure relates to an injection molding machine controller and a program.

### BACKGROUND ART

There has been conventionally known an injection molding machine that includes a hopper which is charged with pellets, melts the pellets in a barrel, and injects the melted pellets into a mold. The injection molding machine has heaters arranged on the outer periphery of the barrel. When the heaters heat the barrel, the pellets are melted.

It is useful to monitor the surface temperature of the heater in order to monitor the state of the heater and calculate a heat dissipation quantity from the heaters. Therefore, installation of sensors for temperature measurement on the surface of the heater, temperature measurement by thermography, estimation of the surface temperature using an equation, and the like are performed. Further, in consideration of heat inflow/outflow at a heating source that heats the barrel, an injection molding machine has been proposed which calculates a temperature at an arbitrary position on the barrel (see, for example, Patent Document 1).
Patent Document 1: Japanese Unexamined Patent Application, Publication No. 2014-46488

### DISCLOSURE OF THE INVENTION

### Problems to be Solved by the Invention

For the estimation of a surface temperature using an equation, temperatures at arbitrary positions along the axial direction and radial direction of the barrel are estimated based on temperatures detected at temperature control points and detection points with additional sensors and the like. However, an actual barrel has holes for sensors, splits and the like. For this reason, the surface temperature of the barrel does not show uniform distribution. As a result, there is a possibility that an error occurs between an estimated temperature and an actual temperature.

Meanwhile, as described in Patent Document 1, it is useful to take into consideration the heat dissipation quantity of the heating source from the viewpoint of reducing energy loss. On the other hand, Patent Document 1 is based on an assumption that the temperature distribution on the surface of the heating source is uniform. Therefore, it is presumed that there is an error in the heat dissipation quantity according to Patent Document 1. In view of the foregoing, it is considered to be favorable to improve the accuracy of the calculated heat dissipation quantity.

### Means for Solving the Problems

(1) The present disclosure relates to a controller for an injection molding machine including a barrel and a heater arranged around the barrel and configured to calculate a heat dissipation quantity of the heater at a predetermined time. The controller includes: an operation information acquisition unit that acquires, as operation information, a heater output of the heater and a set temperature for the heater during a predetermined period immediately before the predetermined time; a surface temperature acquisition unit that acquires a surface temperature of the heater during the predetermined period included in the acquired operation information; a characteristics information acquisition unit that acquires characteristics information indicating characteristics relating to heat dissipation of the heater; a results information acquisition unit that acquires, as results information, results of transition among ratios between the surface temperatures and the set temperature of the heater relative to transition among the heater output of the heater; an estimation unit that estimates a surface temperature of the heater at the predetermined time based on the operation information, the results information and the acquired surface temperatures; and a heat dissipation quantity calculation unit that calculates the heat dissipation quantity from a surface of the heater into an atmosphere, based on the estimated surface temperature and the characteristics information.
(2) The present disclosure relates to a program for causing a computer to function as a controller for an injection molding machine including a barrel and heaters arranged around the barrel and configured to calculate a heat dissipation quantity of the heater at a predetermined time. The program causes the computer to function as units including: an operation information acquisition unit that acquires, as operation information, a heater output of the heater and a set temperature for the heater during a predetermined period immediately before the predetermined time; a surface temperature acquisition unit that acquires a surface temperature of the heater during the predetermined period included in the acquired operation information; a characteristics information acquisition unit that acquires characteristics information indicating characteristics relating to heat dissipation of the heater; a results information acquisition unit that acquires, as results information, results of transition among ratios between the surface temperatures and the set temperature of the heater relative to transition among the heater output of the heater; an estimation unit that estimates a surface temperature of the heater at the predetermined time based on the operation information, the results information and the acquired surface temperatures; and a heat dissipation quantity calculation unit that calculates the heat dissipation quantity from a surface of the heater into an atmosphere, based on the estimated surface temperature and the characteristics information.

### Effects of the Invention

According to the present disclosure, it is possible to provide an injection molding machine controller capable of improving the accuracy of a calculated heat dissipation quantity of heater, and a program.

### BRIEF DESCRIPTION OF THE DRAWINGS

FIG. 1 is a schematic diagram showing an injection molding machine including a controller according to one embodiment of the present disclosure;

FIG. 2 is a table showing an example of results information learned by the controller of the one embodiment;

FIG. 3 is a schematic diagram showing a relationship between the heat generation quantity and heat dissipation quantity of heater of the injection molding machine including the controller of the one embodiment;

FIG. 4 is a block diagram showing a configuration of the controller of the one embodiment;

FIG. 5 is a schematic diagram showing an example of operation information of the controller of the one embodiment;

FIG. 6 is a schematic diagram showing an example of results information of the controller of the one embodiment;

FIG. 7 is a screen diagram showing a screen displayed on a display unit of the controller of the one embodiment;

FIG. 8 is a flowchart showing a flow of operation of the controller of the one embodiment;

FIG. 9 is a screen diagram showing a screen displayed on the display unit of the controller of a Modification Example;

FIG. 10 is a screen diagram showing a screen displayed on the display unit of the controller of another Modification Example;

FIG. 11 is a screen diagram showing a screen displayed on the display unit of the controller of yet another Modification Example; and

FIG. 12 is a screen diagram showing a screen displayed on the display unit of the controller of yet another Modification Example.

### PREFERRED MODE FOR CARRYING OUT THE INVENTION

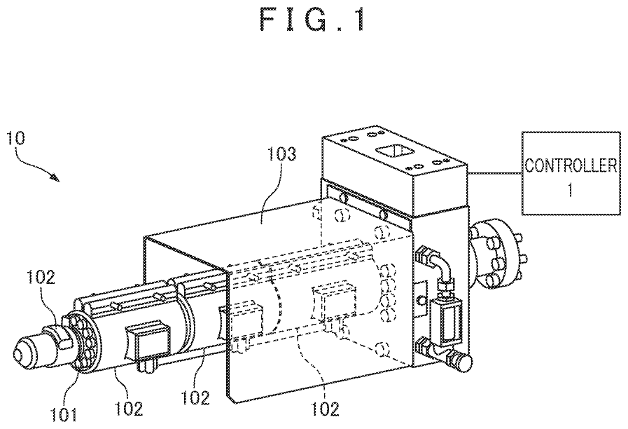

A controller 1 of an injection molding machine 10 and a program according to one embodiment of the present disclosure will be described with reference to FIGS. 1 to 8. First, the injection molding machine controlled by the present embodiment will be described. The injection molding machine 10 is an apparatus that performs molding by melting pellets and injecting the melted pellets into a mold (not shown). For example, as shown in FIG. 1, the injection molding machine 10 is provided with a barrel 101, heaters 102 and a safety cover 103.

The barrel 101 is, for example, a cylindrical body. The diameter of one end portion of the barrel 101 in the axial direction decreases toward the end portion. The barrel 101 has a screw (not shown) inside along the axial direction. While stirring the melted pellets, the screw causes the melted pellets to move to one end side of the barrel 101.

The heaters 102 are arranged around the barrel 101. The plurality of heaters 102 are arranged, for example, along the axial direction of the barrel 101. Specifically, the plurality of heaters 102 are arranged from a nozzle portion at the tip of the barrel 101 in the axial direction up to the base end. In the present embodiment, five heaters 102 are arranged along the axial direction to cover the outer circumference of the barrel 101. The heaters 102 heat the barrel 101, for example, to 200 degrees or higher.

The safety cover 103 is a hollow-shaped body arranged around the heaters 102. The safety cover 103 is arranged to avoid contact with the heaters 102 that get relatively hot.

According to the injection molding machine 10 described above, pellets are melted inside the barrel 101 heated to 200 degrees or higher by the heaters 102. The screw injects the melted pellets into a mold from one end of the barrel 101. Thereby, the injection molding machine 10 molds, for example, a plastic product.

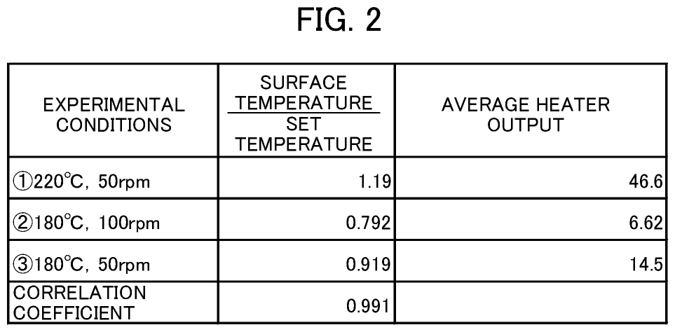

Here, since the safety cover 103 is arranged around the heaters 102, it is not easy to directly measure a surface temperature of the heater 102 from outside. It is known that there is a correlation among an actual surface temperature of the heater 102, a set temperature set for the heaters 102 and a heater output of the heater 102. Specifically, it is known that there is a correlation between an average heater output of the heater 102 and a ratio between the surface temperature of the heater 102 and the set temperature. For example, as shown in FIG. 2, the set temperature for the heaters 102 and the rotation number of the screw were set to (1) 220 degrees and 50 rpm; (2) 180 degrees and 100 rpm, and (3) 180 degrees and 50 rpm. As a result, values of the surface temperature/set temperature were 1.19, 0.792 and 0.919, respectively, and values of the average heater output were 46.6%, 6.62% and 14.5%, respectively. As a result, a correlation coefficient between the surface temperature/set temperature and the heater output was 0.991. Therefore, it turned out that there is a strong correlation between the surface temperature/set temperature and the heater output.

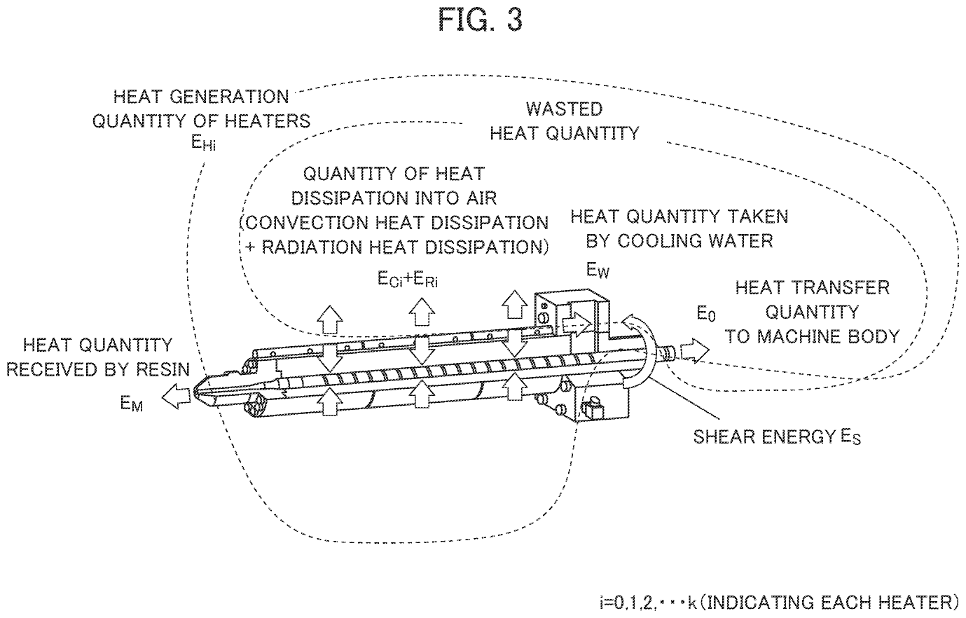

As shown in FIG. 3, a heat generation quantity E_{Hi} of the heater 102 can be shown by a convection heat dissipation quantity E_{Ci}, an radiation heat dissipation quantity E_{Ri}, a heat quantity E_{W} taken by cooling water, a heat transfer quantity E₀ to the machine body (the hopper side), a heat quantity E_{M} received by resin and shear energy E_{S}. Here, i (i=1, 2, . . . , k) is a natural number and indicates a number to identify each of k heaters 102. For example, a quantity of heat dissipation (convection heat dissipation+radiation heat dissipation) into the air is shown by Formula 1 below.

$${\sum }_{i = 0}^{k} ( {E}_{Ci} + {E}_{Ri} ) \approx {\sum }_{i = 0}^{k} ( {E}_{Hi} ) - {E}_{W} - {E}_{0} + {E}_{S} - {E}_{M}$$

The controller 1 for the injection molding machine 10 according to the embodiment estimates the surface temperature of the heater 102 from outside using the above correlation. Thereby, in comparison with estimating the surface temperature of the heater 102 using an equation from temperature control points and detection points of additional sensors and the like, the controller 1 for the injection molding machine 10 according to the embodiment estimates the surface temperature of the heater 102 more accurately. Further, the controller 1 for the injection molding machine 10 according to the embodiment improves the accuracy of an estimated heat dissipation quantity by calculating the heat dissipation quantity from the surface temperature of the heater 102. In the embodiment, “in operation” refers to the moment when the injection molding machine 10 is actually operating. Further, in the embodiment, “predetermined time” refers to such time at which the surface temperature of the heater 102 is to be estimated.

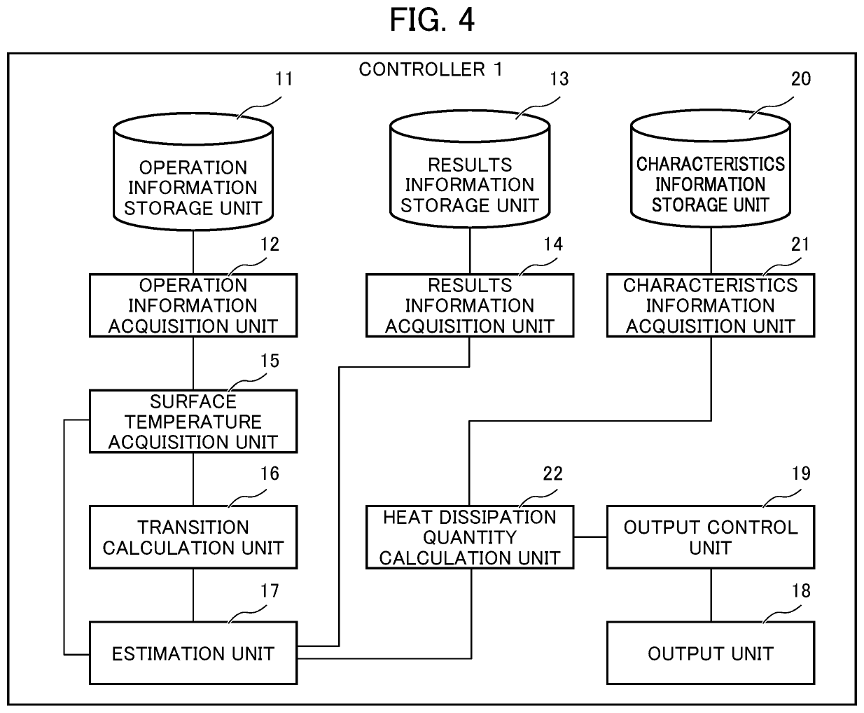

Next, the controller 1 for the injection molding machine 10 according to the one embodiment of the present disclosure will be described with reference to FIGS. 1 to 8. The controller 1 is a device that controls the injection molding machine 10. Specifically, the controller 1 is a device that controls molding conditions of the injection molding machine 10. For example, as shown in FIG. 1, the controller 1 is connected to the injection molding machine 10. The controller 1 performs control, specifying the molding conditions such as speed and pressure of injection molding, temperature of the barrel 101, mold temperature and the quantity of injection of melted pellets. The controller 1 in the present embodiment is a device that calculates the heat dissipation quantity of the heater 102 at a predetermined time. As shown in FIG. 4, the controller 1 is provided with an operation information storage unit 11, an operation information acquisition unit 12, a characteristics information storage unit 20, a characteristics information acquisition unit 21, a results information storage unit 13, a results information acquisition unit 14, a surface temperature acquisition unit 15, a transition calculation unit 16, an estimation unit 17, a heat dissipation quantity calculation unit 22, an output unit 18 and an output control unit 19.

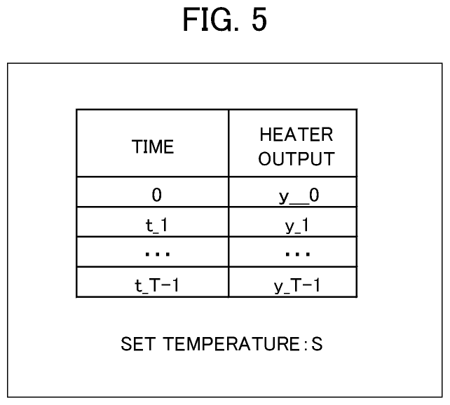

The operation information storage unit 11 is a storage medium, for example, a hard disk. The operation information storage unit 11 stores a set temperature for the heaters 102 of the injection molding machine 10, and operation information about heater outputs of the heaters 102 in operation. Further, the operation information storage unit 11 stores, for example, content of instructions about operation of the injection molding machine 10 as the operation information. The operation information storage unit 11 stores, for example, the above molding conditions as the operation information. For example, as shown in FIG. 5, the operation information storage unit 11 stores heater outputs y_0, y_1, . . . , y_T−1 for each sampling cycle t_1(s) up to t_T−1 immediately before the predetermined time, with operation start time as 0 and the predetermined time as T. The operation information storage unit 11 stores S (° C.) as the set temperature.

The operation information acquisition unit 12 is realized, for example, by a CPU operating. The operation information acquisition unit 12 acquires heater outputs of the heaters 102 and a set temperature for the heaters 102 during a predetermined period immediately before the predetermined time, as the operation information. In the present embodiment, the operation information acquisition unit 12 acquires the operation information from the operation information storage unit 11. The operation information acquisition unit 12 acquires heater outputs of the heaters 102 and a set temperature for the heaters 102 during a period from start of operation of the injection molding machine 10 until immediately before the predetermined time, as the operation information. For example, the operation information acquisition unit 12 acquires heater outputs shown in a predetermined sampling cycle until immediately before the predetermined time.

The characteristics information storage unit 20 is a storage medium, for example, a hard disk. The characteristics information storage unit 20 stores characteristics information indicating characteristics relating to heat dissipation of the heaters 102. The characteristics information storage unit 20 stores information specific to the heaters 102 as the characteristics information. The characteristics information storage unit 20 stores, for example, the surface area, emissivity and Stefan-Boltzmann constant of the heaters 102 as the characteristics information.

The characteristics information acquisition unit 21 is realized, for example, by the CPU operating. The characteristics information acquisition unit 21 acquires the characteristics information about the heaters 102 that includes the surface area of the heater 102.

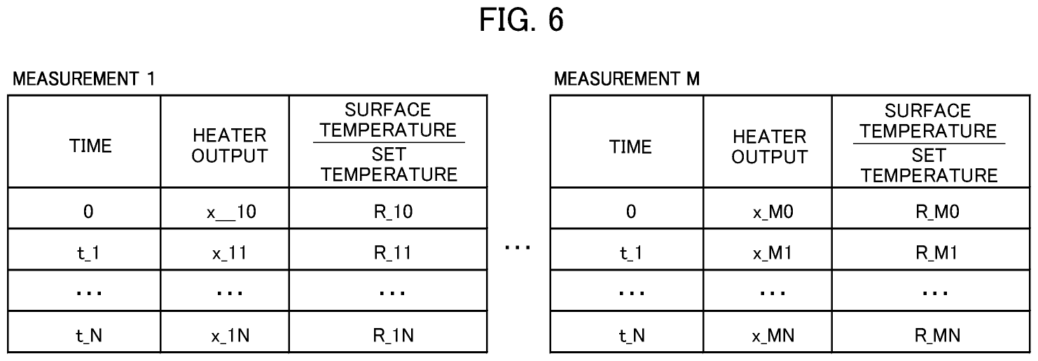

The results information storage unit 13 is a storage medium, for example, a hard disk. The results information storage unit 13 stores results of transition of the ratio between surface temperature of the heater 102 and a set temperature relative to transition of heater output of the heater 102 as results information. For example, with transition among heater output of the heater 102 measured in advance as input data, the results information storage unit 13 stores transition among ratios between surface temperature of the heater 102 measured at the same time and the set temperature (surface temperature/set temperature) as the results information. The results information storage unit 13 stores results information obtained in advance by learning of teaching data with heater outputs as an input. The results information storage unit 13 may store, for example, results information as shown in FIG. 2, which is obtained by learning of a relationship between heater output and surface temperature using temperature sensors (not shown) caused to be in contact with the surface of the heater 102 in advance. The results information storage unit 13 stores, for example, a plurality of results as the results information. For example, as shown in FIG. 6, the results information storage unit 13 stores, for each measured result, results information in which the value of heater output is indicated by x_MN, and the value of surface temperature/set temperature is indicated by R_MN, with a measurement number as M (M is a natural number), measurement start time (operation start time) as 0, and heater output acquisition time as tM_N (N is a natural number).

The results information acquisition unit 14 is realized, for example, by the CPU operating. The results information acquisition unit 14 acquires the results information from the results information storage unit 13. The results information acquisition unit 14 acquires, for example, results of transition among ratios between surface temperatures of the heaters 102 and the set temperature relative to transition among heater outputs of the heaters 102 as the results information. Specifically, the results information acquisition unit 14 acquires, for each heater output in the past, a ratio between a set temperature in the past and a surface temperature in the past (surface temperature/set temperature) as the results information.

The surface temperature acquisition unit 15 is realized, for example, by the CPU operating. The surface temperature acquisition unit 15 acquires surface temperatures of the heaters 102 during a period included in the acquired operation information. The surface temperature acquisition unit 15 acquires, for example, surface temperatures estimated by the estimation unit 17 to be described later within the period included in the acquired operation information. Further, the surface temperature acquisition unit 15 acquires surface temperatures actually measured or provided from outside instead of the estimated surface temperatures. For example, the surface temperature acquisition unit 15 acquires, for each sampling cycle t_1, a surface temperature TP_A (° C.) (A=1, 2, . . . , t−1).

The transition calculation unit 16 is realized, for example, by the CPU operating. The transition calculation unit 16 calculates, based on the acquired operation information and the acquired surface temperatures, transition among ratios between the surface temperatures and the set temperature relative to transition among heater outputs included in the operation information. For example, the transition calculation unit 16 calculates the value of the surface temperature/set temperature for each heater output included in the operation information. In the present embodiment, the transition calculation unit 16 calculates (TP_A/S) (A=1, 2, . . . , t−1) for each sampling cycle t_1.

The estimation unit 17 is realized, for example, by the CPU operating. The estimation unit 17 estimates a surface temperature of the heaters 102 at the predetermined time based on the operation information, the results information and the acquired surface temperatures. Specifically, the estimation unit 17 estimates the surface temperature at the predetermined time using results similar to or coincident with the operation information and the calculated transition among ratios among results included in the results information. The estimation unit 17 estimates the surface temperature at the predetermined time from a ratio between a set temperature and a surface temperature at a time corresponding to the predetermined time, which is shown by the results similar to or coincident with the transition. For example, the estimation unit 17 identifies results corresponding to a period that is similar to or coincident with transition among heater outputs and transition among the ratios between a set temperature and surface temperatures included in operation information during a predetermined period from immediately before the predetermine time. The estimation unit 17 acquires a ratio between a set temperature and a surface temperature at the next time after elapse of the similar or coincident period (corresponding to the predetermined time) included in the identified results. Then, the estimation unit 17 estimates the surface temperature at the predetermined time by multiplying the acquired ratio by the set temperature included in the operation information.

The heat dissipation quantity calculation unit 22 is realized, for example, by the CPU operating. The heat dissipation quantity calculation unit 22 calculates a heat dissipation quantity from the surfaces of the heaters 102 into the atmosphere, based on the estimated surface temperature and the characteristics information. That is, the heat dissipation quantity calculation unit 22 calculates the sum of convection heat dissipation quantity and radiation heat dissipation quantity of the k heaters 102 as the heat dissipation quantity into the air. Here, with the heat dissipation quantity (J) from the heaters 102 into the atmosphere as E_{Ai}, the convection heat dissipation quantity (J) as E_{Ci}, the radiation heat dissipation quantity (J) as E_{Ri}, the surface temperature (K) of the heaters 102 as T_{H}, the surface area (m²) of the heaters 102 as Aᵢ, the heat transfer coefficient (W/m²K) as h, the emissivity as ε, the Stefan-Boltzmann constant (W/m²K⁴) as σ, and the number indicating each of the k heaters 102 as i=1, 2, . . . , k, the heat dissipation quantity calculation unit 22 calculates the heat dissipation quantity E_{Ai} using Formula 2 below.

E_{Ai}=E_{Ci}+E_{Ri}

E_{Ci}=Aᵢ×∫ₜ_{₀}^{t}^{₁}{(T_{H}−T_{R})×h}dt

E_{Ri}=Aᵢ×∫ₜ_{₀}^{t}^{₁}{(T_{H}⁴−T_{R}⁴)×ε×σ}dt

The heat dissipation quantity calculation unit 22 may calculate the heat transfer coefficient h as a function of temperature difference between the surface temperature of the heaters 102 and the atmosphere temperature.

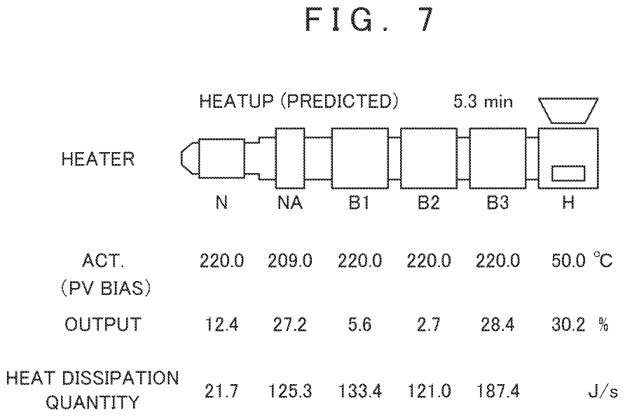

The output unit 18 is, for example, a display unit such as a display. The output unit 18 outputs the calculated heat dissipation quantity to the outside. For example, as shown in FIG. 7, the output unit 18 displays positions of the heaters 102 relative to the barrel 101, a set temperature, heater outputs and heat dissipation quantities.

The output control unit 19 is realized, for example, by the CPU operating. The output control unit 19 causes the output unit 18 to output a calculated heat dissipation quantity.

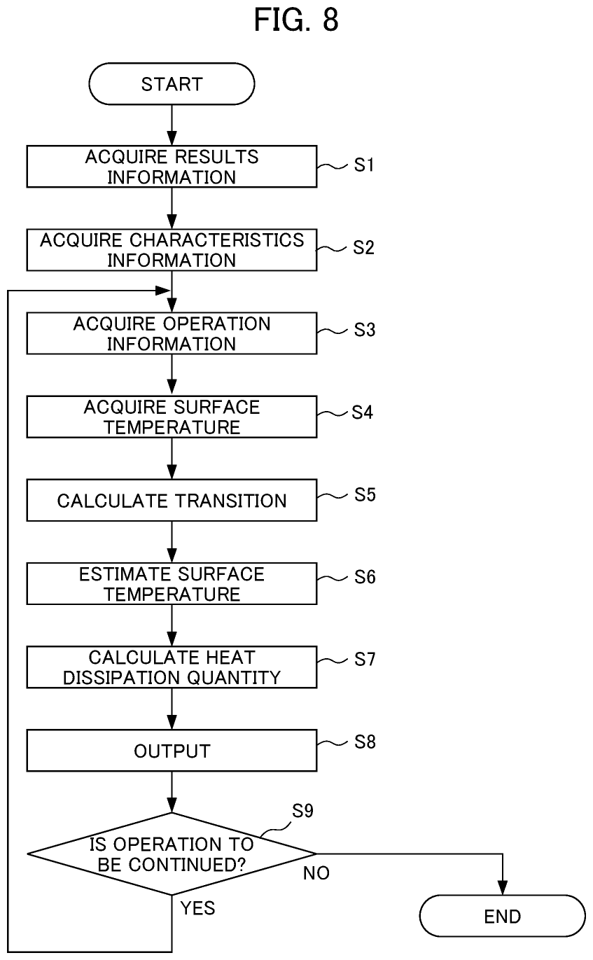

Next, a flow of a process by the controller 1 will be described with reference to FIG. 8. First, the results information acquisition unit 14 acquires results information (Step S1). For example, the results information acquisition unit 14 acquires a plurality of pieces of results information from the results information storage unit 13.

Next, the characteristics information acquisition unit 21 acquires characteristics information (Step S2). The characteristics information acquisition unit 21 acquires, for example, characteristics information stored in the characteristics information storage unit 20 in advance.

Next, the operation information acquisition unit 12 acquires operation information (Step S3). The operation information acquisition unit 12 acquires, for example, operation information stored in the operation information storage unit 11 in advance.

Next, the surface temperature acquisition unit 15 acquires surface temperature corresponding to the operation information (Step S4).

Next, the transition calculation unit 16 calculates, based on the acquired operation information and the acquired surface temperatures, transition among ratios between the surface temperatures and a set temperature relative to transition among heater outputs included in the operation information (Step S5). Next, the estimation unit 17 estimates a surface temperature of the heaters 102 from the operation information, the surface temperatures and the results information (Step S6).

At Step S7, the heat dissipation quantity calculation unit 22 calculates a heat dissipation quantity based on the estimated surface temperature of the heaters 102 and the characteristics information. For example, the heat dissipation quantity calculation unit 22 calculates a heat dissipation quantity for each heater 102.

At Step S8, the output control unit 19 outputs the calculated heat dissipation quantity to the output unit 18. For example, the output unit 18 displays the calculated heat dissipation quantity.

Next, it is determined whether the heat dissipation quantity calculation is to be repeated or not (Step S9). If the calculation is to be repeated (Step S9: YES), the process returns to Step S3. On the other hand, if the calculation is to be ended (Step S9: NO), the process by the present flow ends.

Next, a program of the present embodiment will be described. Each component included in the controller 1 for the injection molding machine 10 can be realized by hardware, software or a combination thereof. Here, being realized by software means that being realized by a computer reading and executing the program.

The program can be stored using any of various types of non-transitory computer-readable medium and supplied to a computer. The non-transitory computer-readable medium include various types of tangible storage medium. Examples of the non-transitory computer-readable medium include magnetic recording medium (for example, a flexible disk, a magnetic tape and a hard disk drive), magneto-optical recording medium (for example, a magneto-optical disk), a CD-ROM (read-only memory), a CD-R, a CD-R/W and semiconductor memories (for example, a mask ROM, a PROM (programmable ROM), an EPROM (erasable PROM), a flash ROM, a RAM (random access memory)). The program may be supplied to the computer by any of various types of transitory computer-readable medium. Examples of the various types of transitory computer-readable medium include an electrical signal, an optical signal and electromagnetic waves. The transitory computer-readable medium can supply the program to the computer via a wired communication channel such as an electric wire and optical fibers or a wireless communication channel.

According to the controller 1 and the program according to the one embodiment, the following effects are obtained.

(1) The controller 1 for an injection molding machine 10 including a barrel 101 and a heater 102 arranged around the barrel 101 and configured to calculate a heat dissipation quantity of the heater 102 at a predetermined time. The controller 1 includes: an operation information acquisition unit 12 that acquires, as operation information, a heater output of the heater 102 and a set temperature for the heater 102 during a predetermined period immediately before the predetermined time; a surface temperature acquisition unit 15 that acquires a surface temperature of the heater 102 during the predetermined period included in the acquired operation information; a characteristics information acquisition unit 21 that acquires characteristics information indicating characteristics relating to heat dissipation of the heater 102; a results information acquisition unit 14 that acquires, as results information, results of transition among ratios between the surface temperatures and the set temperature of the heater 102 relative to transition among the heater output of the heater 102; an estimation unit 17 that estimates a surface temperature of the heater 102 at the predetermined time based on the operation information, the results information and the acquired surface temperatures; and a heat dissipation quantity calculation unit 22 that calculates the heat dissipation quantity from a surface of the heater 102 into an atmosphere, based on the estimated surface temperature and the characteristics information. Further, a program for causing a computer to function as the controller 1 for the injection molding machine 10 including the barrel 101 and the heaters 102 arranged around the barrel 101 and configured to calculate a heat dissipation quantity of the heater 102 at a predetermined time. The program causes the computer to function as units including: the operation information acquisition unit 12 that acquires, as operation information, a heater output of the heater 102 and a set temperature for the heater 102 during a predetermined period immediately before the predetermined time; the surface temperature acquisition unit 15 that acquires a surface temperature of the heater 102 during the predetermined period included in the acquired operation information; the characteristics information acquisition unit 21 that acquires characteristics information indicating characteristics relating to heat dissipation of the heater 102; the results information acquisition unit 14 that acquires, as results information, results of transition among ratios between the surface temperatures and the set temperature of the heater 102 relative to transition among the heater output of the heater 102; the estimation unit 17 that estimates a surface temperature of the heater 102 at the predetermined time based on the operation information, the results information and the acquired surface temperatures; and the heat dissipation quantity calculation unit 22 that calculates the heat dissipation quantity from surface of the heater 102 into an atmosphere, based on the estimated surface temperature and the characteristics information. Thereby, it is possible to improve the accuracy of the estimated surface temperature of the heater 102 more, irrespective of the form (unevenness) around the barrel 101. Further, since it is not necessary to install physical sensors and the like on the surface of the heater 102, costs can be reduced. It is possible to calculate the heat dissipation quantity of each of the heater 102 based on the estimated surface temperature. Therefore, it is possible to calculate the heat dissipation quantity from the surface of the heater 102 into the air more accurately.
As a result, it is possible to lengthen the life of the heater and reduce drive power of the injection molding machine 10 by making such settings for operations and molding conditions that the heat dissipation quantity is minimized.
(2) The controller 1 for the injection molding machine 10 further includes a transition calculation unit 16 that calculates, based on the acquired operation information and the acquired surface temperatures, the transition among the ratios between the surface temperatures and the set temperature relative to the transition among the heater outputs included in the operation information, wherein the estimation unit 17 estimates the surface temperature at the predetermined time using results similar to or coincident with the operation information and the calculated transition among the ratios among the results included in the results information. Thereby, it is possible to easily estimate the surface temperature by acquiring the heater output and the set temperature.
(3) The surface temperature acquisition unit 15 acquires the surface temperature of the heater 102 in the form of the ratios between the surface temperatures and the set temperature of the heater; and the estimation unit 17 estimates the surface temperature at the predetermined time using results similar to or coincident with the operation information and the acquired transition among the ratios among the results included in the results information. Thereby, it is also possible to easily estimate the surface temperature by directly acquiring the ratios between the set temperature and the surface temperatures.
(4) The heat dissipation quantity calculation unit calculates the heat dissipation quantity using a parameter calculated from the surface temperatures as a part of the characteristic information. Thereby, since the estimated surface temperature is used, it is possible to improve the accuracy of the calculated heat dissipation quantity more.

Each preferred embodiment of the injection molding machine controller and the program of the present disclosure has been described above. The present disclosure, however, is not limited to the above embodiment and can be appropriately changed. For example, in the above embodiment, the results information acquisition unit 14 may acquire the results information at a plurality of points on the surface of one heater 102. Thereby, the estimation unit 17 may estimate surface temperatures at the plurality of points on the surface of the one heater 102. Then, the heat dissipation quantity calculation unit 22 may calculate heat dissipation quantities at the plurality of points on the surface of the one heater 102. At this time, the heat dissipation quantity calculation unit 22 may determine the heat dissipation quantities by calculating a convection heat dissipation quantity E_{ci} and an radiation heat dissipation quantity E_{Ri} by Formula 3 below, with the surface temperature (K) of the heater 102 at each measurement point as T_{Hm}, an area (m²) occupied by each measurement point within the surface of the heater 102 as Aᵢₘ, and a number indicating each measurement point as m=1, 2, . . .

$${E}_{Ci} = {\sum }_{m} [ {A}_{im} \times {\int }_{{t}_{0}}^{{t}_{1}} \{ ( {T}_{Hm} - {T}_{R} ) \times h \} dt ] \\ {E}_{Ri} = {\sum }_{m} [ {A}_{im} \times {\int }_{{t}_{0}}^{{t}_{1}} \{ ( {T}_{Hm}^{4} - {T}_{R}^{4} ) \times ε \times σ \} dt ]$$

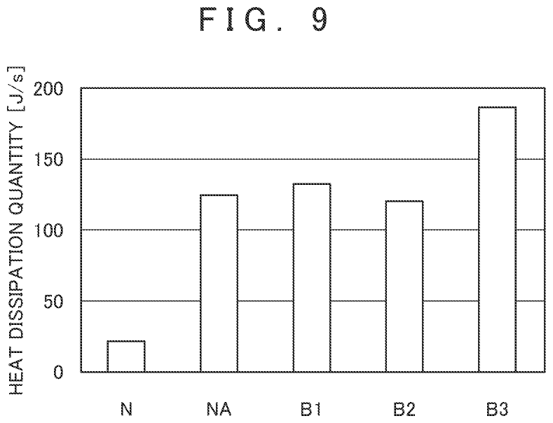

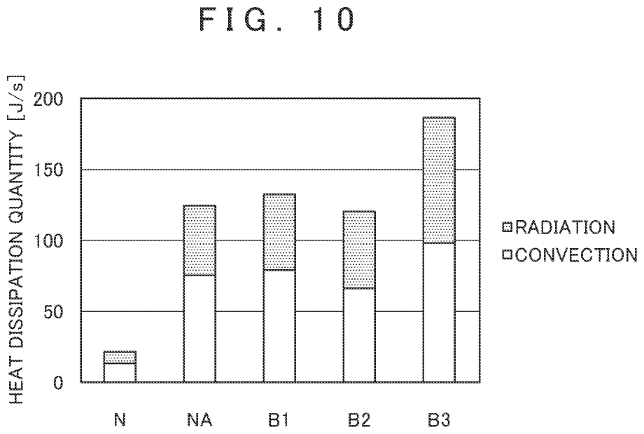

In the above embodiment, the output control unit 19 may cause the output unit 18 to display a heat dissipation quantity with a bar graph for each heater 102 as shown in FIG. 9. Further, the output control unit 19 may cause the output unit 18 to display a convection heat dissipation quantity and an radiation heat dissipation quantity separately as shown in FIG. 10. Thereby, it becomes possible to easily grasp differences among the heaters 102.

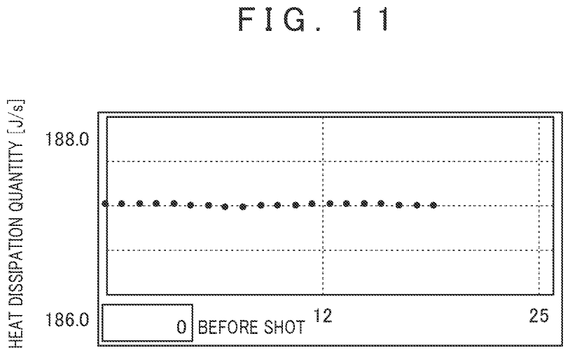

In the above embodiment, the output control unit 19 may cause the output unit 18 to display a scatter plot showing a heat dissipation quantity at each predetermined time as shown in FIG. 11. Thereby, it is possible to chronologically display heat dissipation quantities of the heaters 102, and, therefore, it is possible to make it easy to monitor abnormality of the heat dissipation quantity of the heaters 102.

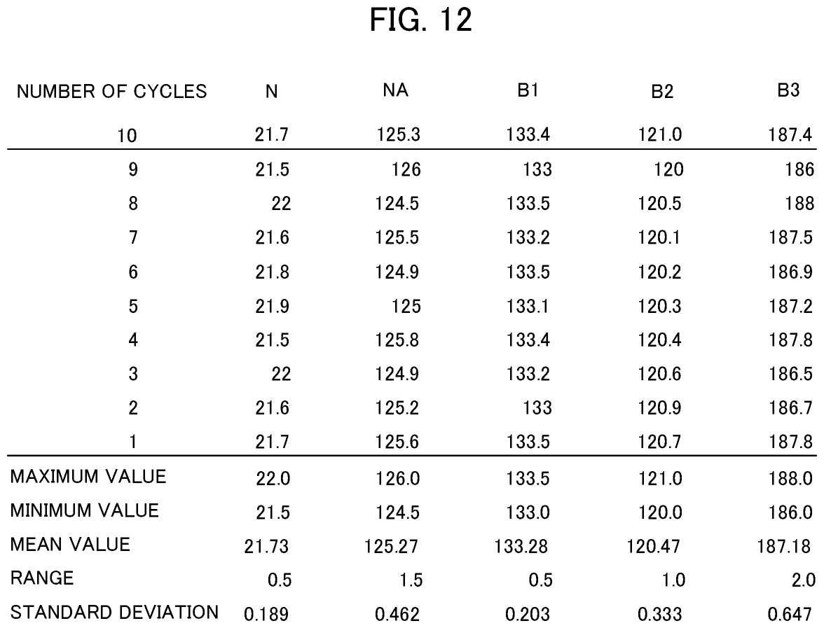

In the above embodiment, the output control unit 19 may cause the output unit 18 to display the heat dissipation quantities of the heaters 102 at each predetermined time in a list as shown in FIG. 12. For example, the output control unit 19 may cause the output unit 18 to display a maximum value, a minimum value, a mean value, a difference between the maximum value and the minimum value, and a standard deviation for each heater 102.

In the above embodiment, the operation information acquisition unit 12 acquires the operation information after the results information acquisition unit 14 acquires the results information. However, the present disclosure is not limited thereto. The operation information acquisition unit 12 may acquire the operation information before acquisition of the results information by the results information acquisition unit 14.

In the above embodiment, the injection molding machine 10 may be of any type between an inline screw type and a plunger type. Further, in the above embodiment, the surface temperature of the heater 102 included in the results information may be a temperature measured by a temperature sensor (not shown) which is a direct method or may be a temperature measured by thermography (an radiation thermometer; not shown) which is an indirect method.

In the above embodiment, the output unit 18 may be configured as a body separate from the controller 1 (the injection molding machine 10). The controller 1 may manage a plurality of injection molding machines 10. Further, in the above embodiment, the output control unit 19 may cause the output unit 18 to display the surface temperature of the heater 102 in addition to the heat dissipation quantity.

In the above embodiment, the heat dissipation quantity calculation unit 22 may calculate a heat dissipation quantity per unit time or for a predetermined time length, such as for each cycle time. Further, in the above embodiment, the heat dissipation quantity calculation unit 22 may calculate a total heat dissipation quantity or a heat dissipation quantity per unit time corresponding to a predetermined time length. Further, the heat dissipation quantity calculation unit 22 may calculate a mean value for each predetermined period of time or a heat dissipation quantity at a particular timing.

In the above embodiment, the operation information acquisition unit 12 may use a detected temperature detected (or a surface temperature estimated) at a temperature control point instead of a set temperature. Further, in the above embodiment, the estimation unit 17 may estimate the surface temperature of the heater 102 on the assumption that the surface temperature of the heater 102 at the time when the injection molding machine 10 starts operation corresponds to E % of the detected temperature at the control point of the heater 102 (E is an arbitrary constant or variable). For example, the estimation unit may estimate the surface temperature as such a variable that E=95 holds if the detected temperature is below 50 degrees, and E=90 holds if the detected temperature is equal to or higher than 50 degrees.

In the above embodiment, the predetermined time is not limited to current time and may be time in the past or in the future. When the predetermined time is time in the past, the operation information acquisition unit 12 acquires heater outputs and setting information during the predetermined period immediately before the predetermined time. When the predetermined time is time in the future, the operation information acquisition unit 12 acquires heater outputs and setting information assumed during the predetermined period immediately before the predetermined time.

In the above embodiment, the surface temperature acquisition unit 15 may acquire, instead of surface temperatures, ratios between a set temperature and surface temperatures. In this case, the controller 1 may not be provided with the transition calculation unit 16.

### EXPLANATION OF REFERENCE NUMERALS

1 Controller
10 Injection molding machine
12 Operation information acquisition unit
14 Results information acquisition unit
16 Transition calculation unit
17 Estimation unit
21 Characteristics information acquisition unit
22 Heat dissipation quantity calculation unit
101 Barrel
102 Heater

1. A controller for an injection molding machine, the injection molding machine comprising a barrel and a heater arranged around the barrel and configured to calculate a heat dissipation quantity of the heater at a predetermined time, the controller comprising:
an operation information acquisition unit that acquires, as operation information, a heater output of the heater and a set temperature for the heater during a predetermined period immediately before the predetermined time;
a surface temperature acquisition unit that acquires a surface temperature of the heater during the predetermined period included in the acquired operation information;
a characteristics information acquisition unit that acquires characteristics information indicating characteristics relating to heat dissipation of the heater;
a results information acquisition unit that acquires, as results information, results of transition among ratios between the surface temperatures and the set temperature of the heater relative to transition of the heater output of the heater;
an estimation unit that estimates a surface temperature of the heater at the predetermined time based on the operation information, the results information and the acquired surface temperatures; and
a heat dissipation quantity calculation unit that calculates the heat dissipation quantity from surface of the heater into an atmosphere, based on the estimated surface temperature and the characteristics information.

2. The controller for the injection molding machine according to the claim 1, the controller further comprising a transition calculation unit that calculates, based on the acquired operation information and the acquired surface temperatures, transition among the ratios between the surface temperatures and the set temperature relative to the transition among the heater outputs included in the operation information, wherein
the estimation unit estimates the surface temperature at the predetermined time using results similar to or coincident with the operation information and the calculated transition among the ratios among the results included in the results information.

3. The controller for the injection molding machine according to the claim 1, wherein
the surface temperature acquisition unit acquires the surface temperature of the heater in a form of the ratios between the surface temperatures and the set temperature of the heater, and
the estimation unit estimates the surface temperature at the predetermined time using results similar to or coincident with the operation information and the acquired transition among the ratios among the results included in the results information.

4. The controller for the injection molding machine according to claim 2 or 3, wherein the estimation unit estimates the surface temperature at the predetermined time from a ratio between a surface temperature and the set temperature at a time corresponding to the predetermined time, which is indicated by the results similar to or coincident with the transition.

5. The controller for the injection molding machine according to any one of claims 1 to 4, wherein the heat dissipation quantity calculation unit calculates the heat dissipation quantity using a parameter calculated from the surface temperatures as a part of the characteristic information.

6. A program for causing a computer to function as a controller for an injection molding machine, the injection molding machine comprising a barrel and a heater arranged around the barrel and configured to calculate a heat dissipation quantity of the heater at a predetermined time, the program causing the computer to function as units comprising:
an operation information acquisition unit that acquires, as operation information, a heater output of the heater and a set temperature for the heater during a predetermined period immediately before the predetermined time;
a surface temperature acquisition unit that acquires a surface temperature of the heater during the predetermined period included in the acquired operation information;
a characteristics information acquisition unit that acquires characteristics information indicating characteristics relating to heat dissipation of the heater;
a results information acquisition unit that acquires, as results information, results of transition among a ratio between the surface temperature and the set temperature of the heater relative to transition among the heater output of the heater;
an estimation unit that estimates a surface temperature of the heater at the predetermined time based on the operation information, the results information and the acquired surface temperatures; and
a heat dissipation quantity calculation unit that calculates the heat dissipation quantity from a surface of the heater into an atmosphere, based on the estimated surface temperature and the characteristics information.
